(19) United States
(12) Patent Application Publication
(10) Pub. No.: US 2024/0388115 A1
(43) Pub. Date: Nov. 21, 2024

(54) METHOD AND DEVICE FOR CHARGING A MULTI-CELL BATTERY

(71) Applicant: Volkswagen Aktiengesellschaft, Wolfsburg (DE)

(72) Inventors: Benjamin BEDUERFTIG, Ulm (DE); Bernd EPDING, Braunschweig (DE)

(73) Assignee: Volkswagen Aktiengesellschaft, Wolfsburg (DE)

(21) Appl. No.: 18/784,927

(22) Filed: Jul. 26, 2024

Related U.S. Application Data
(63) Continuation of application No. PCT/EP2023/050087, filed on Jan. 3, 2023.

(30) Foreign Application Priority Data
Jan. 26, 2022 (DE) 10 2022 200 867.7

(51) Int. Cl. H02J 7/00; B60L 58/13; H01M 10/44

(52) U.S. Cl. CPC H02J 7/007186; B60L 58/13; H01M 10/443; H01M 10/446; H02J 7/0048; B60L 2240/545; B60L 2240/547

(57) ABSTRACT

A method and device for charging a multi-cell battery, wherein prior to beginning the charging a battery voltage of the battery is detected, wherein proceeding from the detected battery voltage a charge quantity-dependent charging voltage characteristic curve is determined, and wherein a charging voltage is controlled and/or regulated on the basis of the determined charging voltage characteristic curve as a function of the charge quantity.

This nonprovisional application is a continuation of International Application No. PCT/EP2023/050087, which was filed on Jan. 3, 2023, and which claims priority to German Patent Application No. 10 2022 200 867.7, which was filed in Germany on Jan. 26, 2022, and which are both herein incorporated by reference.

### BACKGROUND OF THE INVENTION

### Field of the Invention

The invention relates to a method and to a device for charging a multi-cell battery.

### Description of the Background Art

Li-ion cells, depending on the temperature, duration of energization, and state of charge (SOC), can accept only a certain charging current without being damaged. A limiting current defined in this way also changes with the state of health (SOH) of an Li-ion cell. An additional problem is that multiple battery cells, which may have different temperatures, states of charge, and/or states of health, may typically be connected in series or in parallel in a battery system. Therefore, it is generally necessary to know a state of charge and a state of health of all battery cells in the system, as well as the coldest and hottest point of the battery, at any point in time. In addition, temperature gradients within a battery cell must be known in order to actually know the coldest and hottest point in the overall battery system. These two factors, together with the state of charge and the state of health of each battery cell, determine the maximum charging current that is possible at any point in time. Since a relaxed battery cell can temporarily accept a current that is higher than the maximum possible continuous current, the temporal response of the battery cell to the charging current must also be known.

It is known that by the use of three-electrode cells, the maximum possible charging current for Li-ion cells may be determined by controlling the potential of the anode under load. This is possible only in a three-electrode cell having a reference electrode. A reduction in the charging current characteristic curves in proportion to the decrease in the capacity or the increase in the internal resistance of the cell in the aging profile then takes place in the system (for example, see Sieg et al., Journal of Power Sources 427 (2019) 260-270, doi: https://doi.org/10.1016/j.jpowsour.2019.04.047, and DE 10 2016 007 479 A1).

Furthermore, it is known that the maximum pulse current for each state of charge for a relaxed battery cell may be determined using the three-electrode cells. This is known from DE 10 2019 003 465 A1, for example, which describes a method for charging a battery. In this method, a plurality of starting states of charge and a plurality of ambient temperatures are predefined. For each combination of one of the starting states of charge and one of the ambient temperatures, an associated reference charging current curve for charging the battery is recorded and stored in a reference charging current characteristic curve.

Moreover, it is known that charging current characteristic curves are checked for their harmfulness as a function of temperature, state of charge, and pulse duration by repeated application to the battery, and subsequently appropriately predefined for the system. It is customary not only to respond to the aging of the battery cells in the system, but also to plan in advance for a safety margin for the charging currents.

In general, it is problematic that in the starting situation prior to charging, a state of charge (SOC), a state of health (SOH), and a temperature of the battery cells in a battery are generally not known or are not accurately determinable, and/or must be determined using additional measures.

### SUMMARY OF THE INVENTION

It is therefore an object of the invention to improve a method and a device for charging a multi-cell battery.

In particular, a method for charging a multi-cell battery is provided, wherein prior to beginning the charging, a battery voltage of the battery is detected, wherein based on the detected battery voltage a charge quantity-dependent charging voltage characteristic curve is determined, and wherein a charging voltage is controlled and/or regulated based on the determined charging voltage characteristic curve as a function of the charge quantity.

Furthermore, in particular a device for charging a multi-cell battery is provided that includes a control unit, the control unit being configured to receive a battery voltage of the battery that is detected prior to beginning the charging, and based on the detected battery voltage, to determine a charge quantity-dependent charging voltage characteristic curve, and to control and/or regulate a charging voltage based on the determined charging voltage characteristic curve as a function of the charge quantity.

The method and the device allow controlled and/or regulated charging of the battery based on a battery voltage detected prior to the charging. This is achieved by determining a charge quantity-dependent charging voltage characteristic curve, based on the battery voltage that is detected prior to the charging. The charging voltage is controlled and/or regulated based on the determined charging voltage characteristic curve. In particular, a value of the charging voltage characteristic curve, determined based on a charge quantity using the charging voltage characteristic curve, specifies the charging voltage. The charge quantity is in particular a charge quantity that is recharged for charging the battery; i.e., prior to the charging a value of this charge quantity is in particular equal to zero, and at the end of the charging a target charge quantity is reached. For this purpose, the control unit obtains, in particular as input values, a charge quantity that is already recharged, on this basis determines a value of the charging voltage characteristic curve, and uses it as the present setpoint value for the charging voltage. This is repeated during the charging, so that the setpoint value for the charging voltage is continuously determined. The charging ends in particular when a predefined charge quantity or a final value of the charging voltage characteristic curve is reached.

An advantage of the method and of the device is that the battery voltage has to be measured only once. Other measures such as determining a battery cell voltage, a battery cell temperature, and the respective states of charge, etc., are not necessary.

The device may be used in a battery system, for example, to charge a battery of the battery system. In particular, the device may be situated in a vehicle, in particular a motor vehicle, for example an electric vehicle or hybrid vehicle, and used there. However, in principle the vehicle may also be some other land or rail vehicle, or watercraft, aircraft, or spacecraft, for example a drone or an air taxi.

A battery cell can be an Li-ion battery cell. A battery then in particular can include multiple such Li-ion battery cells.

Portions of the device, in particular the control unit, may be designed, individually or collectively, as a combination of hardware and software, for example as program code that is executed on a microcontroller or microprocessor. However, it may also be provided that portions are designed, individually or collectively, as an application-specific integrated circuit (ASIC) and/or field-programmable gate array (FPGA).

For determining the charging voltage characteristic curve, the detected battery voltage can be inserted as a parameter into a parameterizable charging voltage characteristic curve that can be stored with the battery voltage. The effort in determining the charging voltage characteristic curve may thus be minimized, since the complete charging voltage characteristic curve does not have to be determined; rather, it is necessary only to parameterize a parameterizable charging voltage characteristic curve that is already determined and stored. The parameterizable charging voltage characteristic curve can be stored in a memory of the control unit, for example, and may be retrieved therefrom as needed. By insertion of the detected battery voltage, the charging voltage characteristic curve can then be completely parameterized, so that a relationship between the charge quantity and the charging voltage is known for any charge quantity, or may be determined using the charging voltage characteristic curve parameterized in this way. The charging voltage characteristic curve and the parameterizable charging voltage characteristic curve differ in particular only by the parameter “battery voltage,” and are otherwise identical (i.e., the battery voltage is already inserted into the charging voltage characteristic curve).

The charging voltage characteristic curve and/or the parameterizable charging voltage characteristic curve are/is or have/has been determined, taking into account a predefined open circuit voltage curve of the battery cells, a predefined threshold voltage curve of the battery cells, and an interconnection of the battery cells. As a result, when the battery is being charged, during the charging at no point in time does the charging voltage characteristic curve assume a value that causes a threshold voltage of the battery cells to be exceeded. The threshold voltage is in particular the voltage above which damage to the battery cell occurs, in particular due to lithium plating. On the other hand, the charging voltage determined using the charging voltage characteristic curve is to be selected in such a way that it is greater than a respective open circuit voltage of the battery cells. To obtain the battery voltage based on a consideration of the individual battery cells, in addition the interconnection (series and/or parallel) of the individual battery cells is taken into account. The threshold voltage curve and the open circuit voltage curve are determined, for example, based on empirical test series and/or by simulation using methods known per se, and may then be correspondingly predefined for the battery cells.

For determining the charging voltage characteristic curve and/or the parameterizable charging voltage characteristic curve: for a predefined ending state of charge, a difference between the predefined threshold voltage curve and the predefined open circuit voltage curve is or has been determined, based on a starting voltage that is determined at a predefined starting state of charge, using the determined difference and the open circuit voltage curve, a characteristic curve profile between the predefined starting state of charge and the predefined ending state of charge is or has been determined, and based on the determined difference, the determined characteristic curve profile, and the interconnection of the battery cells within the battery, the charging voltage characteristic curve and/or the parameterizable charging voltage characteristic curve are/is or have/has been determined. As a result, during the charging between the predefined starting state of charge and the predefined ending state of charge of the battery cells, in particular at no point in time do the voltages at the battery cells exceed the threshold voltage. The predefined starting state of charge and the predefined ending state of charge are in particular values that are generally predefined for all battery cells. A predefined starting state of charge may be, for example, 5% or 20% of a maximum charge quantity in the battery cell. The predefined ending state of charge may be, for example, 80% of the maximum charge quantity of the battery cell. The predefined starting state of charge and the predefined ending state of charge are values which are used for determining the charging voltage characteristic curve and/or the parameterizable charging voltage characteristic curve, but which do not have to match the actual values of the individual battery cells.

A profile of the charging voltage characteristic curve and/or of the parameterizable charging voltage characteristic curve can be linear, and/or that the characteristic curve profile is or has been determined as a linear profile. A particularly easily determinable charging voltage characteristic curve may be provided in this way. In particular, the charging voltage characteristic curve may have a profile that has essentially the following form:

$$charging voltage = f ( charge quantity ) = detected battery voltage + determined difference + voltage slope \times charge quantity$$

The voltage slope may be determined in particular by adding the determined difference to the particular open circuit voltage at the starting state of charge (5% or 20%, for example) and at the ending state of charge (80%, for example), and between the resulting values, determining the slope with regard to the charge quantity between the starting state of charge and the ending state of charge.

A profile of the charging voltage characteristic curve and/or of the parameterized charging voltage characteristic curve may also have a different form, for example as a quadratic function, a polynomial function, a power function, an exponential function, a logarithmic function, etc.

When determining the charging voltage characteristic curve and/or the parameterizable charging voltage characteristic curve, a reduction for a temperature difference of battery cells connected in series and/or a reduction for a temperature difference of battery cells connected in parallel, and/or a reduction for a state of charge difference of battery cells connected in series are/is or have/has been taken into account. A safety margin for a temperature difference and/or a state of charge difference may thus be taken into consideration. The reductions are taken into consideration in particular in the form of pre-exponential factors.

Furthermore, in particular a battery system is also provided, comprising at least one device according to the described examples.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of an example of the device for charging a multi-cell battery;

FIG. 2 shows a schematic illustration of an example of a battery and an interconnection of the battery with charge control achieved by means of the device;

FIG. 3 shows a schematic illustration for explaining the determination of the charging voltage characteristic curve; and

FIGS. 4a to 4d show schematic illustrations of electrical variables as a function of time during charging of a battery, in a simulation for clarifying the invention.

### DETAILED DESCRIPTION

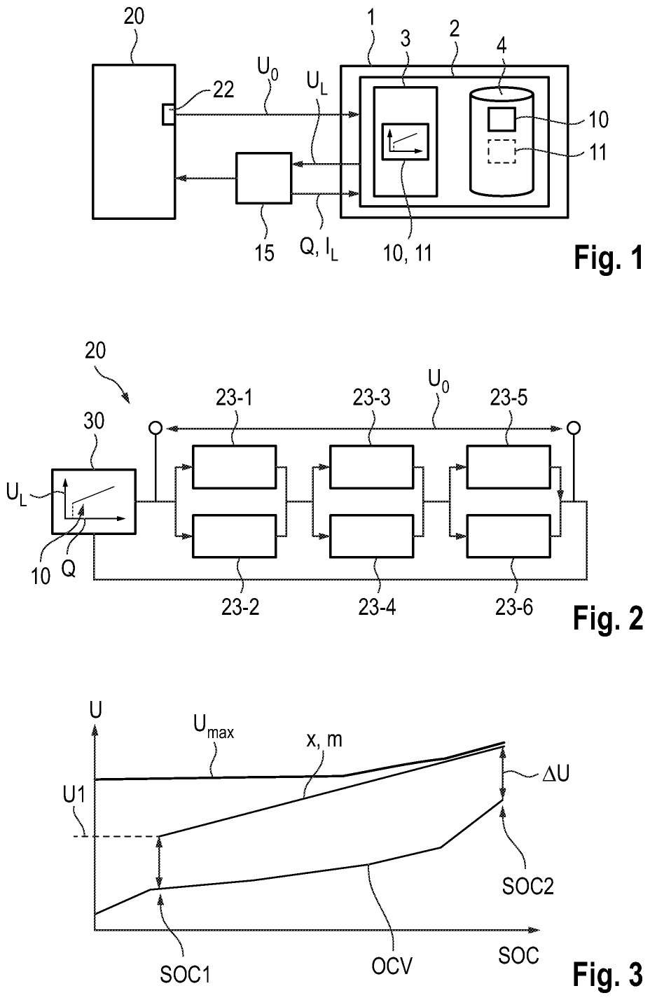

FIG. 1 shows a schematic illustration of an example of the device 1 for charging a multi-cell battery 20. The device 1 may in particular be part of a battery system. The device 1 carries out the method described in the present disclosure.

The device 1 includes a control unit 2. The control unit 2 has a computer 3 and a memory 4, for example.

The control unit 2 is configured to receive a battery voltage U₀ of the battery 20 that is detected prior to beginning the charging. For this purpose, the battery voltage U₀ is detected at the battery 20 and transmitted as a signal to the control unit 2, for example using a suitable sensor system 22.

Based on the detected battery voltage U₀, the control unit 2 determines a charge quantity-dependent charging voltage characteristic curve 10. For this purpose, for example appropriate program code is executed on the computer 3. The control unit 2 controls or regulates a charging voltage U_{L} based on the determined charging voltage characteristic curve 10 as a function of the charge quantity. A value of the charging voltage U_{L} is supplied to a converter 15, for example, which generates the charging voltage U_{L} for charging (only schematically illustrated here). For this purpose, it is provided in particular that a recharged charge quantity Q is detected and/or determined, for example by integrating a detected charging current I_{L}. For detecting the charging current I_{L}, for example a current sensor (not shown) that is appropriately configured for this purpose may be used in or at the converter 15.

It may be provided that for determining the charging voltage characteristic curve 10, the detected battery voltage U₀ is inserted as a parameter into a parameterizable charging voltage characteristic curve 11 that is stored with the battery voltage U₀. For this purpose, the computer 3 retrieves the parameterizable charging voltage characteristic curve 11 from the memory 4 and inserts the detected or received battery voltage U₀ into the parameterizable charging voltage characteristic curve 11, thus obtaining the charging voltage characteristic curve 10.

It may be provided that the charging voltage characteristic curve 10 and/or the parameterizable charging voltage characteristic curve 11 are/is or have/has been determined, taking into account a predefined open circuit voltage curve OCV of the battery cells 23-x of the battery 20, a predefined threshold voltage curve Uₘₐₓ of the battery cells 23-x, and an interconnection of the battery cells in the battery 20. This is schematically explained by way of example, with reference to FIGS. 2 and 3.

FIG. 2 shows a schematic illustration of an example of a battery 20, an interconnection of the battery 20, and charge control 30 achieved by use of the device 1. The battery 20 includes six battery cells 23-x connected in parallel in pairs, the battery cells 23-x, in each case connected in parallel, being connected in series. States of charge and temperatures of the individual battery cells 23-x may differ from one another.

FIG. 3 shows a schematic illustration in which the voltage U is plotted on the ordinate (y axis) and the state of charge SOC is plotted on the abscissa (x axis). An individual battery cell is considered. An open circuit voltage curve OCV and a threshold voltage curve Uₘₐₓ are illustrated. The charging voltage characteristic curve 10 and/or the parameterizable charging voltage characteristic curve 11 (FIG. 1) are/is determined in particular in such a way that during the charging, at no point in time does a profile of a voltage at an individual battery cell exceed the threshold voltage curve Uₘₐₓ. In principle, various suitable curve shapes may be used, as described above.

In one refinement, it may be provided in particular that for determining the charging voltage characteristic curve 10 (FIG. 1) and/or the parameterizable charging voltage characteristic curve 11 (FIG. 1), for a predefined ending state of charge SOC2 a difference ΔU between the predefined threshold voltage curve Uₘₐₓ and the predefined open circuit voltage curve OCV is or has been determined:

$$Δ U = {U}_{max} ( SOC 2 ) - OCV ( SOC 2 )$$

SOC2 is selected, for example, to be a state of charge of 80% of a total charge quantity of the battery cell. Furthermore, based on a starting voltage U1 that is determined at a predefined starting state of charge SOC1 using the determined difference ΔU and the open circuit voltage curve OCV:

$$U 1 = OCV ( SOC 1 ) + Δ U ,$$

a characteristic curve profile between the predefined starting state of charge SOC1 and the predefined ending state of charge SOC2 is determined. The starting state of charge SOC1 is selected, for example, to be 5% or 20% of the total charge quantity of the battery cell. In particular, it is provided that the characteristic curve profile is or has been determined as a linear profile. For this purpose, in particular a slope of a straight line X is determined:

$$m = \frac{{U}_{max} ( SOC 2 ) - U 1}{SOC 2 - SOC 1}$$

The charging voltage characteristic curve 10 and/or the parameterizable charging voltage characteristic curve 11 are/is determined based on the determined difference AU, the determined characteristic curve profile, and the interconnection of the battery cells within the battery.

Proceeding from the example described above, it may be provided, for example, that the charging voltage characteristic curve 10 takes on the following form:

$${U}_{L} ( Q ) = f ( Q ) = {U}_{0} + Δ U \cdot s + \frac{s}{p} \cdot m \cdot Q ,$$

where s is the number of battery cells connected in series (in the example shown in FIG. 2, s=3), and p is the number of battery cells connected in parallel (in the example shown in FIG. 2, p=2).

For the recharged charge quantity Q, in particular the following applies at a time t:

$$Q = \int {I}_{L} dt$$

$$Δ U \cdot s + \frac{s}{p} \cdot m η$$

has already been determined, the parameterizable charging voltage characteristic curve 11 may be provided. The parameterizable charging voltage characteristic curve 11 may then be stored for retrieval in the memory 4 of the control unit 2, and may be retrieved therefrom as needed and parameterized with the detected battery voltage U₀, so that the charging voltage characteristic curve 10 may be created therefrom. However, it may also be provided that the charging voltage characteristic curve 10 is not determined until prior to the charging.

It is pointed out that the charging voltage characteristic curve 10 or the parameterizable charging voltage characteristic curve 11 is or becomes defined only in the interval from 0 to (SOC2-SOC1). In particular, a charging operation is terminated when a recharged charge quantity Q has reached the value SOC2-SOC1.

The charging voltage characteristic curve 10 and/or the parameterizable charging voltage characteristic curve 11 and/or the characteristic curve profile may also be nonlinear, for example designed as a quadratic function, a polynomial function, a power function, an exponential function, a logarithmic function, or another such function.

It may be provided that when determining the charging voltage characteristic curve 10 and/or the parameterizable charging voltage characteristic curve 11, a reduction A_{T,s} for a temperature difference of battery cells connected in series and/or a reduction A_{T,p} for a temperature difference of battery cells connected in parallel and/or a reduction A_{SOC,s} for a state of charge difference of battery cells connected in series are/is or have/has been taken into account.

The charging voltage characteristic curve 10 stated above then takes on in particular the following form:

$${U}_{L} ( Q ) = f ( Q ) = {U}_{0} + Δ U \cdot ( 1 - {A}_{T , s} ) \cdot s + \frac{s}{p} \cdot ( ( 1 - {A}_{T , p} ) \cdot ( 1 - {A}_{SOC , s} ) ) \cdot m \cdot Q$$

The charging voltage characteristic curve 10 ensures that the battery 20 (FIGS. 1 and 2) can be charged solely by controlling and/or regulating the charging voltage U_{L} without one of the battery cells 23-x (FIG. 2) in the battery 20 reaching the threshold voltage Uₘₐₓ during the charging. This takes place strictly as a function of a charge quantity Q that is already recharged. The charging of the battery 20 may be greatly simplified by use of the method and the device 1, since a state of charge, a state of health, and/or a temperature of the individual battery cells no longer have/has to be known. In particular, costs and effort may be saved in this way.

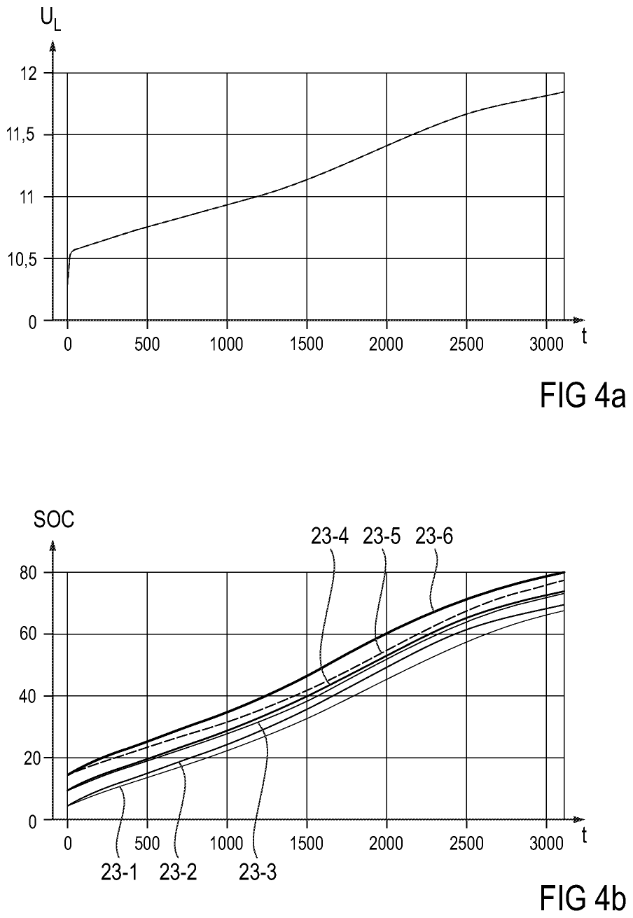

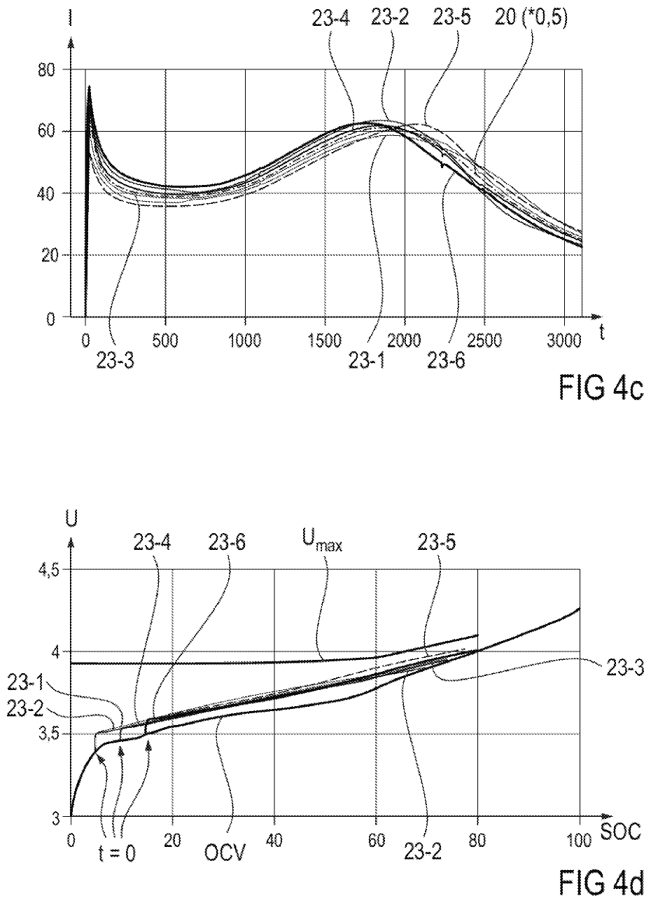

FIGS. 4a through 4d show, by way of example, schematic illustrations of electrical variables as a function of time during charging of a battery 20 having six battery cells 23-x in the interconnection shown in FIG. 2, in an example state. The state encompasses the following values, for example:

$$Battery cell 23 - 1 \text{:} SOC = 5 \% , T = 25 ° C .$$

$$Battery cell 23 - 2 \text{:} SOC = 5 \% , T = 35 ° C .$$

$$Battery cell 23 - 3 \text{:} SOC = 10 \% , T = 35 ° C .$$

$$Battery cell 23 - 4 \text{:} SOC = 10 \% , T = 40 ° C .$$

$$Battery cell 23 - 5 \text{:} SOC = 15 \% , T = 25 ° C .$$

$$Battery cell 23 - 6 \text{:} SOC = 15 \% , T = 40 ° C .$$

Based on this starting situation, a simulation has been performed using battery cell models, with the charging carried out using the method, described in the present disclosure, in the course of a charge quantity-dependent regulation of the charging voltage. The above charging voltage characteristic curve 10 is used as the charging voltage characteristic curve 10, with the following values:

$$Δ U = {U}_{max} ( 80 \% ) - OCV ( 80 \% ) = 4.095 V - 3.9 \; 95 V = 0.1 V$$

$$U 1 = OCV ( 5 \% ) + Δ U = 3.372 V + 0.1 V = 3.4 \; 72 V$$

$$SOC 2 - SOC 1 = 168750 As$$

$$m = \frac{{U}_{max} ( 80 \% ) - U 1}{SOC 2 - SOC 1} = \frac{4.0 \; 95 V - 3.4 \; 72 V}{16 \; 8750 As} = \frac{0.6 \; 23 V}{16 \; 8750 As} = 3.692 \frac{mV}{As}$$

$${A}_{T , s} = 0.1$$

$${A}_{T , p} = 0.1$$

$${A}_{S O C , s} = 0.1$$

The battery voltage prior to the charging is set in the simulation as:

U₀=10.284 V

The charge quantity between 5% (=SOC1) and 80% (=SOC2) of the maximum charge quantity is a property of the battery cells or of the battery.

FIG. 4a shows a profile of the regulated charging voltage U_{L} (in volts) as a function of time t (in seconds). It is clearly apparent that at the beginning (at approximately t=0 seconds), regulation takes place from a battery voltage U₀, below this level, to a setpoint variable that is determined using the charging voltage characteristic curve. The voltage is subsequently steadily increased over time, since the recharged charge quantity increases.

FIG. 4b shows a profile of the states of charge SOC (in %) of the individual battery cells 23-x as a function of time t (in seconds). Since the battery cells 23-x have different states of charge SOC and temperatures at the beginning of the charging (t=0), a profile of the states of charge SOC over time t is also different. When one of the battery cells 23-x reaches a state of charge SOC of 80% (in the shown example, battery cell 23-6), the charging is terminated. This is due to the fact in particular that the charging voltage characteristic curve used for regulating the charging voltage has been determined with regard to an ending state of charge of 80%.

FIG. 4c shows a profile of a particular charging current I (in A) of the individual battery cells 23-x, and a halved charging current of the battery 20 as a function of time t (in seconds). The charging current of the battery 20 is halved due to the fact that in the simulated example, two battery cells 23-x are always connected in parallel (see FIG. 2), so that the current is divided approximately equally over the respective battery cells 23-x connected in parallel.

FIG. 4d shows a profile of the cell voltages U (in V) of the individual battery cells 23-x as a function of a state of charge (in % of a total charge quantity or total capacity of the battery cells 23-x). The threshold voltage curve Uₘₐₓ and the open circuit voltage curve OCV are also illustrated. The different starting points (SOC at 5%, 10%, and 15%) assumed in the example, from which the curves of the individual battery cells 23-x at point in time t=0 proceed, are clearly apparent. It is also clearly apparent that none of the curves exceeds the threshold voltage curve Uₘₐₓ. The charging operation is ended as soon as one of the battery cells 23-x reaches a state of charge of 80%.

A remaining distance between the curves and the threshold voltage curve Uₘₐₓ at the end of the charging operation (for an SOC between approximately 72 to 80%, depending on the curve) results in particular from the specification or selection of the values for the reductions A_{T,s}, A_{T,p}, A_{SOC,s}. If the values for the reductions are selected to be smaller, the curves may be provided closer to the threshold voltage curve Uₘₐₓ.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for charging a multi-cell battery, the method comprising:
detecting, prior to beginning a charging, a battery voltage of the battery;
determining, based on the detected battery voltage, a charge quantity-dependent charging voltage characteristic curve; and
controlling and/or regulating a charging voltage based on the determined charging voltage characteristic curve as a function of the charge quantity.

2. The method according to claim 1, wherein, for determining the charging voltage characteristic curve, the detected battery voltage is inserted as a parameter into a parameterizable charging voltage characteristic curve that is stored with the battery voltage.

3. The method according to claim 1, wherein the charging voltage characteristic curve and/or the parameterizable charging voltage characteristic curve are/is or have/has been determined, taking into account a predefined open circuit voltage curve of the battery cells, a predefined threshold voltage curve of the battery cells, and an interconnection of the battery cells.

4. The method according to claim 3, wherein for determining the charging voltage characteristic curve and/or the parameterizable charging voltage characteristic curve:
for a predefined ending state of charge, a difference between the predefined threshold voltage curve and the predefined open circuit voltage curve is or has been determined,
based on a starting voltage that is determined at a predefined starting state of charge, using the determined difference and the open circuit voltage curve, a characteristic curve profile between the predefined starting state of charge and the predefined ending state of charge is or has been determined, and
based on the determined difference, the determined characteristic curve profile, and the interconnection of the battery cells within the battery, the charging voltage characteristic curve and/or the parameterizable charging voltage characteristic curve are/is or have/has been determined.

5. The method according to claim 1, wherein a profile of the charging voltage characteristic curve and/or of the parameterizable charging voltage characteristic curve is linear, and/or that the characteristic curve profile is or has been determined as a linear profile.

6. The method according to claim 1, wherein, when determining the charging voltage characteristic curve and/or the parameterizable charging voltage characteristic curve, a reduction for a temperature difference of battery cells connected in series and/or a reduction) for a temperature difference of battery cells connected in parallel and/or a reduction for a state of charge difference of battery cells connected in series are/is or have/has been taken into account.

7. A device to charge a multi-cell battery, the device comprising:
a control unit to receive a battery voltage of the battery that is detected prior to beginning a charging, and based on the detected battery voltage, to determine a charge quantity-dependent charging voltage characteristic curve, and to control and/or regulate a charging voltage based on the determined charging voltage characteristic curve as a function of the charge quantity.

8. The device according to claim 7, wherein, for determining the charging voltage characteristic curve, the control unit is further configured to insert the detected battery voltage as a parameter into a parameterizable charging voltage characteristic curve that is stored with the battery voltage.

9. The device according to claim 8, wherein the control unit is further configured to carry out the determination of the charging voltage characteristic curve and/or of the parameterizable charging voltage characteristic curve, taking into account a predefined open circuit voltage curve of the battery cells, a predefined threshold voltage curve of the battery cells, and an interconnection of the battery cells.

10. The device according to claim 9, wherein for determining the charging voltage characteristic curve and/or the parameterizable charging voltage characteristic curve, the control unit, is further configured:
for a predefined ending state of charge, to determine a difference between the predefined threshold voltage curve and the predefined open circuit voltage curve,
based on a starting voltage that is determined at a predefined starting state of charge, using the determined difference and the open circuit voltage curve to determine a characteristic curve profile between the predefined starting state of charge and the predefined ending state of charge, and
based on the determined difference, the determined characteristic curve profile, and the interconnection of the battery cells within the battery, to determine the charging voltage characteristic curve and/or the parameterizable charging voltage characteristic curve.
